(19) United States
(12) Patent Application Publication
(10) Pub. No.: US 2026/0330127 A1
(43) Pub. Date: Oct. 22, 2026

(54) SYSTEMS AND METHODS FOR GRAPH-BASED USER-GUIDED LONG-FORM DOCUMENT GENERATION

(71) Applicant: Patentext, Inc., Boulder, CO (US)

(72) Inventors: Alexander Ross Flake, Boulder, CO (US); Marcus Joseph Virginia, Minneapolis, MN (US)

(21) Appl. No.: 19/643,774

(22) Filed: Apr. 9, 2026

Related U.S. Application Data
(60) Provisional application No. 63/786,080, filed on Apr. 9, 2025.

(51) Int. Cl. G06F 40/166; G06F 16/901; G06F 40/106

(52) U.S. Cl. CPC G06F 40/166; G06F 16/9024; G06F 40/106

(57) ABSTRACT

A graph-based user-guided long-form document generation system and associated method address limitations in existing drafting tools that lack visibility into generative model understanding and fail to maintain consistent concept representations throughout document creation. The system comprises a concept graph database storing nodes and edges representing conceptual entities extracted from source documents, a document data model with an editor block tree and block-graph association pointer, and a user interface module featuring a source pane with graph visualization and a document editor pane containing concept block with attribution indicator. A context construction engine performs graph traversal with proximity weighting to assemble generation context, while a prompt construction engine builds structured prompt from templates. The method generates a concept graph from input documents, serializes the graph into an initial document structure, presents the graph for user selection, constructs context via graph traversal, and replaces concept block with generated text.

### CROSS REFERENCE TO RELATED APPLICATIONS

This Application claims the benefit of U.S. Provisional Application No. 63/786,080, filed on 9 Apr. 2025, which is incorporated in its entirety by this reference.

### TECHNICAL FIELD

This invention relates generally to the field of graph-based generative long-form document authoring system 100 and more specifically to new and useful system 100 and method S100 for graph-based user-guided long-form document generation in the field of graph-based generative long-form document authoring system 100.

### BACKGROUND

The drafting of long-form technical documents, such as patent applications, scientific papers, and engineering specifications, presents significant challenges when employing generative language models. Conventional approaches to automated document generation treat the underlying language model as an opaque system 100, providing users with little or no visibility into what information the model has captured or how the model interprets the technical subject matter being described. This opacity creates a “black box” drafting process in which users cannot verify whether the generative system 100 has accurately understood the invention or technical concepts prior to text generation, leading to unpredictable outputs and requiring extensive manual review and correction.

Maintaining consistency across lengthy documents poses additional difficulties for existing generative drafting tools. As document generation progresses, the contextual foundation upon which the language model operates tends to shift from the original source materials to previously generated in-document text. This contextual drift causes the representation of concepts and relationships to become unstable over the drafting lifecycle, resulting in degraded output quality, inconsistent terminology, and contradictory statements appearing in later sections of the document. Prior system 100 lack mechanisms to anchor concept representations in a stable form that persists throughout the entire document generation process.

Existing drafting tools also fail to adequately represent the complex structural and relational information inherent in technical subject matter. Technical documents frequently describe intricate relationships among components, multi-step processes, hierarchical system 100 architectures, and causal interactions between elements. Generic language models and copilot-style writing assistants process such information as unstructured text, losing the explicit structural relationships that define how components interact or how process steps depend upon one another. No widely adopted approach provides a representation format that captures structural and relational information in a form that is simultaneously machine-usable for driving document generation and human-readable for verification and editing.

Users of generic large language models and copilot-style drafting assistants face substantial mental overhead when producing long-form technical documents. These users must simultaneously manage document structure, track detailed technical context across multiple sections, and formulate appropriate prompts to elicit desired content from the generative model. The cognitive burden of maintaining awareness of both the document organization and the underlying technical details limits productivity and increases the likelihood of errors or omissions in the resulting document.

Prior generative drafting system 100 rely heavily on ad hoc prompting and iterative re-prompting to produce document content. Each section or paragraph typically requires users to craft new prompts, manually incorporate relevant context, and repeatedly refine outputs through trial and error. This approach lacks repeatability and does not leverage a persistent structured representation from which document sections can be systematically generated. The absence of a graph-structured workflow means that changes to the underlying technical content require users to manually propagate those changes through subsequent prompts rather than having updates automatically reflected in the generation process.

Algorithmic derivation of document outlines and hierarchical structures from underlying technical content remains poorly supported in existing system 100. Document organization in prior tools typically requires manual specification by users or relies on generic templates that do not adapt to the specific concepts and relationships present in the source material. No established approach enables automatic construction of document block structures based on traversal or analysis of a graph representing the technical subject matter, independent of any particular generative language model.

Association between document locations and the specific technical concepts those locations describe is weak or nonexistent in conventional drafting tools. Prior system 100 do not maintain explicit mappings between sections, content blocks, or subtopics and corresponding entities in a structured representation of the technical subject matter. Without such associations, constructing appropriate context for generating a particular document section requires manual selection and assembly of relevant information rather than principled traversal of relationships and proximity-based weighting of related concepts.

User interfaces for existing drafting tools do not support interaction paradigms that leverage structured representations of technical content. Users cannot select entities from visual graph views, search results, or categorized lists and place those entities into an editor to specify where and how generative evaluation should occur. The absence of drag-and-drop or similar direct manipulation interfaces for graph-derived entities forces users to rely on textual prompting as the sole mechanism for directing document generation.

Out-of-order drafting workflows receive insufficient support in prior generative system 100. Technical documents frequently require authors to draft sections in a sequence that differs from the final document order, with later sections informing the content of earlier sections. Existing tools do not represent unevaluated sections and their associated conceptual entities in a manner that allows those sections to contribute to the generation context for currently evaluated sections, forcing users to either draft strictly in order or manually manage cross-references between sections.

Reversibility of generated content back to underlying conceptual representations is not provided by conventional drafting tools. Once a generative model produces text for a concept or section, that text replaces any structured representation that may have existed, severing the link between the generated content and its conceptual origin. Users cannot revert generated paragraphs to their originating conceptual form for re-evaluation or modification without losing the association between the text and the underlying structured representation.

Attribution and traceability mechanisms linking generated text to source concepts are inadequate in existing system 100. When a generative model produces a paragraph or section, prior tools do not record which specific entities, relationships, or source materials contributed to that output. This lack of attribution hinders validation of generated technical content, makes verification of accuracy difficult, and prevents users from understanding the provenance of specific statements within the document.

### SUMMARY

Generally, the system for graph-based, user-guided long-form document generation (hereinafter “the system”) executes the method S100 for graph-based user guided document generation (hereinafter “the method S100”) to enable the user to generate a well-structured and conceptually nuanced long-form document with minimal manual prompting. The system accomplishes this by initially generating a concept graph that functions as a topic map that is visually accessible to the user, thereby enabling the user to select concepts, relationships between concepts, and/or attributes associated with either of these graph items to construct complex prompts for evaluation by a generative model. Additionally, because each concept graph item is related to other concept graph items via nodes and edges, the system can traverse the graph to identify and aggregate related context to include in the prompt to a generative model. Furthermore, the system can represent concept graph items as concept block 222 in-line within a document editor pane 220 enabling in-line replacement and further prompt and context aggregation control by utilizing the relative position of concept graph items within the document editor pane 220

The system can include multiple software modules representing instructions configured to execute steps of the method S100. The system can be implemented as a distributed system over a local or wide area network (e.g., the internet), including a user device that renders a user interface and receives inputs from the user, and/or a set of backend servers executing various modules of the system. In some embodiments, the system 100 can interface with third-party services via APIs or web hooks. The third-party services can include, but are not limited to, generative model providers, embedding services, and/or database services.

Generally, the system can: generate a concept graph in step S110; optionally, serialize the concept graph into an initial document structure in step S112; present or render the a set of concept graph items at a user device in step S120; receive a selection of a subject concept graph item in step S130; insert a concept block 222 for the subject concept graph item into the document editor pane 220, in step S140, or, inserting a concept block 222 for the subject concept graph item in a set of concept blocks 222 based on the serialization of the concept graph in step S142; receive an evaluation input to evaluate the concept block 222 for the subject concept graph item in step S150; traverse the graph to construct prompt context in step S160; constructing a prompt based on the position of the concept block 222 within the long-form document in step S170; evaluating the generative model in step S180; and replacing the concept block 222 with the generative output in step S190. In some implementations, the system 100 can additionally propagate edits from the graph to existing generative output.

Generally, the system 100 generates a user interface at a user device including at least two panes (e.g., a graph item pane and a document editor pane 220), thereby enabling the user to view a visual representation of the set of concept graph items and at least a portion of the long-form document within a document editor pane 220. This enables the user to easily select concept graph items for inclusion in the long-form document as a concept block 222. Additionally, the system 100 can render these panes side-by-side to enable the user to provide a drag-and-drop gesture to simultaneously select a subject concept graph item and determine the position of a corresponding concept block 222 within the document. Thus, the system 100 facilitates quick construction of complex topics for evaluation by a generative model.

More specifically, the method S100 for long-form document generation can include, generating a concept graph from a set of input documents, the concept graph including a set of concept graph items including a set of nodes, each node in the set of node including node contents, and a set of edges in step S110. The method S100 also includes, at a user device: at a user device: rendering a visual representation of the set of concept graph items in step S120; receiving a selection of a subject concept graph item, from the set of concept graph items, for inclusion in a long-form document in step S130; in response to receiving the selection of the subject concept graph item, rendering a subject concept block for the subject concept graph item within a document editor pane of the long-form document in step S140; and receiving an evaluation input associated with the subject concept block in step S150. Additionally, the method S100 includes, in response to receiving the evaluation input associated with the subject concept block: traversing the concept graph starting from the subject concept graph item, to aggregate the node contents of each traversed node in a set of traversed nodes within a prompt context in step S160; constructing a prompt based on a position of the subject concept block within the long-form document in step S170; and evaluating a generative model based on the prompt context and the prompt, to generate a generative output in step S180. Further, the method S100 further includes, at the user device, visually replacing the subject concept block with the generative output in step S190.

In one variant, the method S100 for long-form document generation can include: generating a concept graph from a set of input documents, the concept graph including a set of concept graph items including a set of nodes, each node in the set of node including node contents, and a set of edges in step S110; and serializing the concept graph as an ordered hierarchical list of the set of concept graph items in step S112. The method S100 also includes, at a user device: at a user device: rendering a visual representation of the set of concept graph items in step S120; for each concept graph item in the set of concept graph items, rendering a concept block in a set of concept block in a document editor pane of a long-form document based on the ordered hierarchical list of the set of concept graph items in step S142; and receiving an evaluation input associated with the subject concept block in step S150. Additionally, the method S100 includes, in response to receiving the evaluation input associated with the subject concept block: traversing the concept graph starting from the subject concept graph item, to aggregate the node contents of each traversed node in a set of traversed nodes within a prompt context in step S160; constructing a prompt based on a position of the subject concept block within the long-form document in step S170; and evaluating a generative model based on the prompt context and the prompt, to generate a generative output in step S180. Further, the method S100 further includes, at the user device, visually replacing the subject concept block with the generative output in step S190.

### BRIEF DESCRIPTION OF FIGURES

FIG. 1 is a schematic representation of one variant of the graph-based user-guided long-form document.

FIG. 2 is a flowchart representation of one variant of the method of user-guided long-form document generation using a concept graph.

FIG. 3 is a flowchart representation of one variant of the method of user-guided long-form document generation using a concept graph.

FIG. 4 is a representation of one variant of a user interface rendering.

FIG. 5 is a representation of one variant of a user interface rendering.

### DETAILED DESCRIPTION

The following description of embodiments of the invention is not intended to limit the invention to these embodiments but rather to enable a person skilled in the art to make and use this invention. Variants, variations, configurations, embodiments, implementations, example implementations, and examples described herein are optional and are not exclusive to the variants, variations, configurations, embodiments, implementations, example implementations, and examples they describe. The invention described herein can include any and all permutations of these variants, variations, configurations, embodiments, implementations, example implementations, and examples.

Generally, the term “can,” as utilized herein, indicates an action or attribute of the system 100, which may or may not be executed by or be applicable to the system depending on the implementation or embodiment of the system.

Generally, the term “include,” as utilized herein, can mean “comprise,” “consist of,” or “consist essentially of” and is not restricted to any one of the above interpretations throughout.

Generally, the term “a set of,” as utilized herein, refers to one or more of the subject objects. Additionally, the terms “first,” “second,” “third,” etc., as utilized herein, do not imply an order but simply identify multiple instances of a step or component unless an order or series is otherwise implied.

Generally, the term “defining,” as utilized herein, describes elements of a subject, is open-ended, and does not exclude additional unrecited elements or method steps.

Generally, the term “engine” or “module,” as utilized herein, describes a hardware- and/or software-implemented functional unit configured to execute a particular function or functions.

Generally, the capitalized terms “step” and “steps,” as utilized herein, refer to any step or steps of a method depicted in a figure or any variant or more specific implementation of those depicted steps.

Generally, the conjunction “and/or,” as utilized herein, describes, in the alternative, the same list including the conjunction “and” and the same list including the conjunction “or.” For example, the phrase “A, B, and/or C,” as utilized herein, is equivalent to “only A; only B; only C; A and B; B and C; A and C; or A, B, and C.” Thus, “and/or” is utilized herein to describe each possible combination of the items included in a list that includes at least one of the items in the list.

Generally, the term “long-form document,” as utilized herein, is not restricted to a particular length and can describe a text or multimodal document of any length.

Generally, the term “concept graph,” as utilized herein, describes a data structure comprising a set of nodes representing concepts and a set of edges representing relationships between concepts, wherein the nodes and edges are organized according to a flexible ontology that is customizable to a particular application or document domain. A concept graph may be directed or undirected, cyclic or acyclic, hierarchical or non-hierarchical, and may be generated externally, internally, by user input, or by any combination thereof.

Generally, the term “concept graph items,” as utilized herein, describes the constituent elements of a concept graph, including nodes, edges, node attributes, and edge attributes. Any concept graph item may serve as a document-structuring unit, such as a section heading, a topic, or a subtopic, regardless of whether the concept graph item is a node, an edge, or an attribute thereof. The term “concept graph item” may also be used interchangeably with the terms “concept graph entity” or simply “graph entity.”

Generally, the term “node contents,” as utilized herein, describes any data stored within a node of a concept graph, including but not limited to textual descriptions, multimodal content, structured attributes, metadata, labels, and references to external data sources. Node contents are the information aggregated during graph traversal for inclusion in a prompt context.

Generally, the term “subject concept block,” as utilized herein, describes the particular concept block within a document editor pane that is currently undergoing evaluation or is otherwise the focus of a user interaction at a given point in time, as distinguished from other concept block present in the document.

Generally, the term “concept block,” as utilized herein, describes a document element or its visual representation within a document editor pane that is associated with a concept graph item and that, upon evaluation, produces generated text derived from the associated concept graph item and its surrounding context within the concept graph. Prior to evaluation, a concept block displays identifying information of its associated concept graph item, such as the name or label of the associated node, edge, or attribute. Following evaluation, a concept block may be replaced by, or transitioned to display, the generative output.

Generally, the term “evaluation input,” as utilized herein, describes any user action or system-initiated trigger that initiates the context-construction-to-generation pipeline for a given concept block. An evaluation input may take the form of a button click, a keyboard shortcut, a context menu selection, an automatic trigger based on a predetermined condition, a batch evaluation command, or any other mechanism that causes the system to begin constructing a prompt context and prompt for the associated concept block.

Generally, the term “visual representation,” as utilized herein, describes a rendered depiction of a described object. When used in reference to the set of concept graph items, “visual representation” describes the overall display of concept graph items within a source interface, which may take the form of a graph visualization, a text-based search interface, a list view, or any combination thereof. When used in reference to an individual concept graph item, “visual representation” describes the individual depiction of that item within the source interface, such as a node rendered within a graph visualization or an entry rendered within a list.

Generally, the term “prompt context,” as utilized herein, describes the aggregated information derived from traversal of a concept graph that is provided to a generative model as the informational basis for text generation. The prompt context may not be functionally distinct from the prompt itself as both contribute to the series of input tokens for a single inference of a generative model. However, the prompt context supplies the subject matter information about which to generate text, while the prompt supplies instructions governing how to generate the text. A prompt context may include node contents, node attributes, edge attributes, and other information gathered during graph traversal, which may be organized according to the traversal strategy employed.

Generally, the term “position,” as utilized herein, when used in reference to a concept block within a long-form document, describes the location of the concept block within the document structure, encompassing one or more of: the sequential order of the concept block among sibling blocks, the nesting depth of the concept block within the document hierarchy, the relationship of the concept block to a parent section, and the relationship of the concept block to other concept block in the document, whether evaluated or unevaluated.

Generally, the term “ordered hierarchical list,” as utilized herein, describes a serialization of a concept graph that preserves both an ordering of concept graph items and a hierarchical nesting structure among concept graph items, such that the ordered hierarchical list represents a document-ready structure derived from the topology of the concept graph. An ordered hierarchical list may take the form of an indented list, a tree structure, a nested outline, or any other representation that encodes both sequence and parent-child relationships among concept graph items.

Generally, the term “neighboring concept graph items,” as utilized herein, describes concept graph items that are proximate to a subject concept graph item within an ordered hierarchical list, including but not limited to parent items, child items, sibling items, and items within a configurable range of the subject concept graph item in the ordered hierarchical list. The determination of which concept graph items qualify as neighboring may be governed by the traversal algorithm employed by the system.

Generally, the term “proximity-based weighting,” as utilized herein, describes a strategy for assigning relative importance to node contents aggregated during graph traversal, wherein node contents of traversed nodes that are closer to the subject concept graph item in an ordered hierarchical list are weighted more heavily than node contents of traversed nodes that are farther from the subject concept graph item. Proximity may be measured by the number of intervening items in the ordered hierarchical list, by hierarchical distance, or by any combination thereof. Proximity-based weighting may be implemented categorically (e.g., by increasing or decreasing a level of summarization of the node contents), or numerically (e.g., by modifying a parameter associated with the node contents indicating to the generative model to reduce the importance of the node contents).

Generally, the term “generative output,” as utilized herein, describes the output produced by a generative model in response to a prompt context and a prompt, which may include raw text, formatted text, multi-modal content, structured content, or any combination thereof. A generative output may undergo optional post-processing, such as formatting, attribution tagging, iterative modification, or structural adaptation, before being rendered in the document editor.

Generally, the term “propagation input,” as utilized herein, describes a user action or system-initiated trigger that causes the system to update a concept graph based on edits made to a generative output within a document editor pane. A propagation input may take the form of an explicit user action such as a button click or menu selection, an automatic detection of edits meeting a predetermined criterion, or a batch propagation command applied to a set of edited generative outputs. Alternatively, a “propagation input” can also describe a propagation initiated from the concept graph, toward the long-form document.

Generally, the term “attribute,” as utilized herein, when used in reference to a concept graph item, describes any property, metadata, type label, or stored value associated with the concept graph item, including but not limited to node attributes, edge attributes, item type designations, item names, and user-defined properties. An attribute may contain textual information, numerical values, categorical labels, or references to other data, and may be used as an input to prompt construction, as a basis for document structuring, or as a concept graph item.

Generally, the term “based on,” as utilized herein, describes a relationship in which a first element uses a second element as at least one input among potentially multiple inputs. A step or operation described as being performed “based on” a particular element does not require that the particular element be the sole input to the step or operation, but rather that the particular element is among the inputs considered in performing the step or operation.

The system and method described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and method of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer-readable media, such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

As a person skilled in the art will recognize from the following detailed description and from the figures and claims, modifications and changes can be made to the embodiments of the invention without departing from the scope of this invention as defined in the claims.

### Graph-Based User-Guided Long-Form Document Generation System

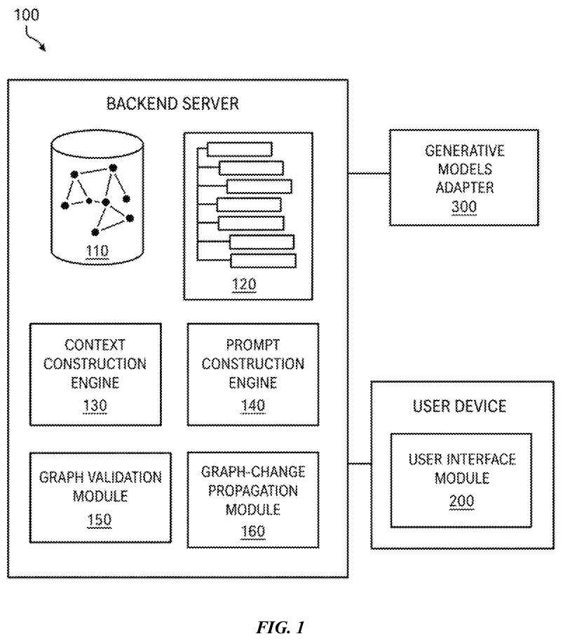

Generally, as shown in FIG. 1, the system 100 can be configured to generate long-form documents by leveraging a concept graph as a persistent and machine-usable representation of document subject matter. The system 100 can include a concept graph database 110, a document data model 120, a user interface module 200 with a configurable source pane 210 and/or document editor pane 220, a context construction engine 130, a prompt construction engine 140, a generative module adapter 300, a graph validation module 150, and/or a graph-change propagation module 160. In operation, the system 100 can receive input documents and/or user-provided topics and can generate a concept graph including nodes and edges, where nodes represent concepts, components, steps, and/or relationships, and edges represent relationships between nodes. The system 100 can expose the concept graph to a user through visual interfaces, including graph visualization, search, and/or list views, enabling the user to verify, edit, and/or manipulate the graph structure directly. More specifically, users can select graph-derived entities (e.g., nodes, edges, and/or attributes) and place them into a document editor pane 220 as concept block 222, which can be associated with source graph entities via pointers maintained by the document data model 120. Upon user-triggered and/or automatic evaluation of a concept block 222, the system 100 can traverse the concept graph starting from the associated entity, aggregate relevant node contents and attributes according to proximity-based weighting and construct a prompt incorporating graph-derived context and/or the position of the block within a document hierarchy. The system 100 can then transmit the prompt to an external generative model via an application programming interface, receive generated text, and insert the resulting output into the document editor pane 220. Additionally, or alternatively, the system 100 can support reversible evaluation, allowing generated text to be reverted to an originating concept block 222, and can maintain attribution between generated paragraphs and source graph entities. Thus, the system 100 can address technical challenges related to lack of visibility into generative model understanding, context drift during drafting, and manual context management by providing a persistent, graph-structured workflow that enables transparency, repeatability, and consistency throughout the document drafting lifecycle.

### Concept Graph Database

As shown in FIG. 1, the graph-based user-guided long-form document generation system 100 can include a concept graph database 110 configured to maintain a graph-based data structure including nodes, edges, and associated attributes. The concept graph database 110 can support a flexible ontology that allows the definition and/or storage of arbitrary node types, edge types, and/or attribute schemas, which may be customized for different document domains and/or use cases. In one embodiment, the concept graph database 110 can employ a relational database (e.g., PostgreSQL) with tables for nodes, edges, and attributes, where foreign-key constraints enforce referential integrity and JSONB columns store flexible attribute bags. The concept graph database 110 can expose query application programming interfaces (APIs) that allow other subsystems to retrieve, update, and/or traverse graph entities and relationships thereof. Thus, the concept graph database 110 addresses the technical challenge of representing complex structural and relational information in a machine-usable yet human-readable form by providing a persistent, queryable storage layer that maintains a stable representation of concepts and relationships across the entire drafting lifecycle.

Generally, the concept graph database 110 can include a node and edge store configured to persistently record the structure and contents of a concept graph. The node and edge store can utilize a key-value database, a graph-native database, and/or any other data storage architecture capable of representing nodes (concepts), edges (relationships), and associated attribute payloads. Each node can represent a discrete concept, such as a component, step, and/or attribute relevant to the document domain, and can store node contents including identifiers, labels, metadata, and/or user- or system-defined attributes. Each edge can represent a directed and/or undirected relationship between nodes, and can store edge type, source and target node references, and/or any edge-specific attributes or metadata. More specifically, the node and edge store can support operations for creating, reading, updating, and/or deleting nodes and edges, as well as for querying the graph structure to support traversal, context construction, and/or serialization processes. Thus, the node and edge store enables the system 100 to maintain visibility into what the generative language model receives as context by providing a structured, persistent repository that can be directly inspected and manipulated by users.

### Document Data Model

As shown in FIG. 1, system 100 can include a document data model 120. Generally, the document data model 120 can comprise a structured, ordered-tree data structure that represents the hierarchical organization of a long-form document. The document data model 120 can support algorithmic outline generation, whereby the system 100 maps concept graph topology into an initial block hierarchy, reducing manual outlining effort and/or ensuring structural parity with the concept graph. Additionally, the document data model 120 can facilitate dynamic context retrieval by supplying a context construction engine 130 with graph pointers, ancestry chains, sibling sets, and/or evaluated-state metadata associated with a target block, thereby enabling graph traversal and proximity weighting algorithms to execute with reduced latency and/or without redundant graph lookups. The document data model 120 can be instantiated as an ordered-tree structural backbone in which every node represents a discrete editor block and every edge represents parent-child containment, with sibling ordering explicitly stored so that a deterministic document sequence is preserved during serialization and/or re-hydration. Thus, the document data model 120 can address challenges associated with representing complex structural and relational information in a machine-usable yet human-readable form, and/or can reduce mental overhead for users who would otherwise manually manage document structure and detailed technical context.

In one embodiment, the document data model 120 can be implemented as a flat-list with parent ID embodiment. In this embodiment, the hierarchy can be represented as a flat list of block records, each carrying a parent-block identifier and/or a sibling order integer. This relational embodiment can suit SQL back-ends and/or can facilitate server-side pagination for large documents while still reconstructing the ordered tree in memory when required. The flat-list with parent ID embodiment can thus provide flexibility in storage implementation while maintaining the structural fidelity required for algorithmic traversal and/or context retrieval.

In another embodiment, the document data model 120 can support a paragraph-toggle evaluation embodiment. In this embodiment, an original content block can be preserved after evaluation by storing a generated paragraph as a child node with a render-as flag. Toggling visibility between the content block and the generated paragraph can be performed without structural mutation, which can improve auditability in regulated drafting environments. This embodiment can address challenges associated with reversible in-place evaluation, whereby generated text can be reverted back to an originating conceptual representation without losing the underlying structured linkage.

### User Interface Module

Generally, the system 100 can include a user interface module 200, deployed and executed at a user device, and configured to render interactive visual representations of a concept graph, a document editor pane 220, and associated interaction controls. The user interface module 200 can employ a multi-pane layout framework capable of instantiating two or more concurrently visible panes and dynamically resizing or collapsing the panes without reloading application state. In one implementation, pane definitions within the multi-pane layout framework are declarative, allowing a rendering engine of the user interface module 200 to switch between split-view, stacked, and/or tabbed presentations at runtime while maintaining underlying block-graph associations.

In one embodiment, the user interface module 200 is implemented as a web-based single-page application. More specifically, the web-based single-page application can be constructed using HTML5, WebGL, and/or TypeScript and can be executed within web browsers. Client-side state can be maintained in a local storage mechanism, such as IndexedDB, so that graph edits persist across offline sessions. Additionally, or alternatively, the web-based single-page application can receive real-time collaboration events via WebSockets or similar protocols. This embodiment provides visibility into the structured representation of an invention while enabling collaborative drafting workflows across distributed users.

In another embodiment, the user interface module 200 is implemented as a desktop application. The desktop application can package the same codebase inside a shell, thereby enabling access to local file system 100 for native export and import of concept graph and/or documents. Additionally, the desktop application can utilize operating-system-level menus and shortcut APIs for enhanced capabilities. This embodiment enables users to directly manipulate the structured representation underlying generation while leveraging native file system capabilities for document management.

### Source Pane

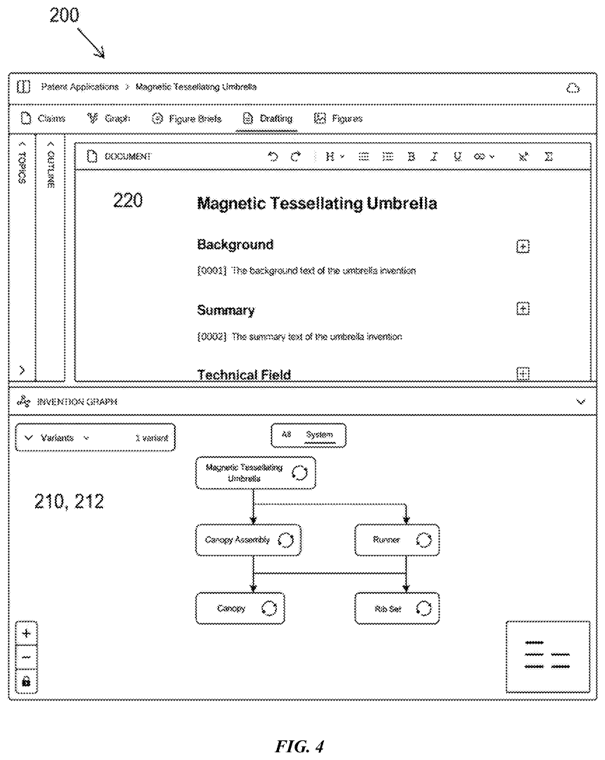

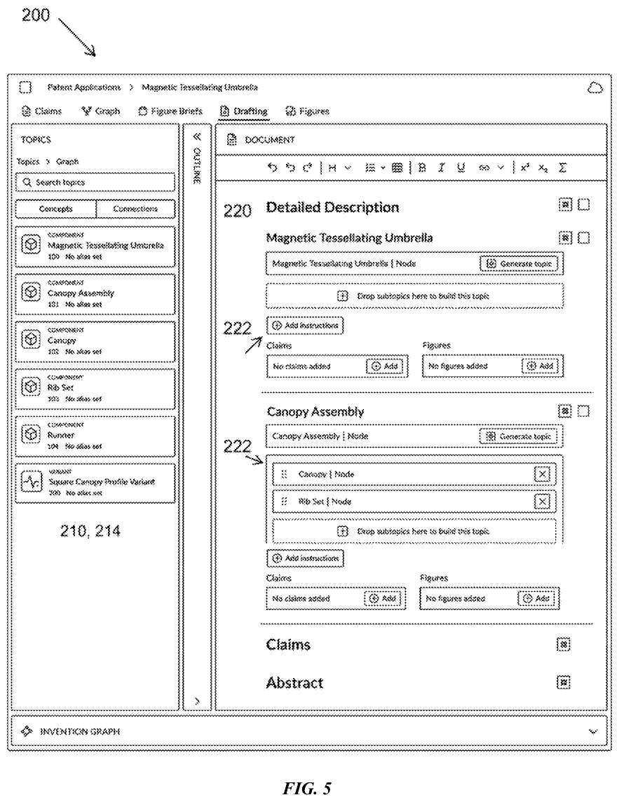

As shown in FIG. 4 and FIG. 5, the source pane 210 can be a configurable user interface component that presents the set of concept graph items in the concept graph to a user in one or more selectable formats. Generally, the source pane 210 can facilitate graph entity selection by enabling a user to view, navigate, and/or interact with nodes and edges of the underlying concept graph. More specifically, the source pane 210 can capture user input gestures (e.g., click, tap, drag-and-drop, and/or marquee selection) to designate one or more graph entities as subjects for downstream operations. In response to a selection event, the source pane 210 can expose an identifier and/or metadata associated with the selected entity to external modules, thereby initiating operations such as concept block 222 creation, attribute inspection, and/or contextual assistance. The source pane 210 can render the concept graph in a dedicated pane, a modal dialog, and/or as part of a unified interface alongside the document editor pane 220. Additionally or alternatively, the source pane 210 can support multiple simultaneous views, filtering, and/or search functionalities to enable efficient navigation and selection of graph entities. Thus, the source pane 210 can address the challenge of high mental overhead for users who must manually manage both document structure and detailed technical context by providing a direct visual and/or list-based interface for manipulating the concept graph.

### Graph Visualization Interface

As shown in FIG. 4, the graph visualization interface 212 can render a visual representation of the concept graph on an interactive display. Generally, the graph visualization interface 212 can transform node and edge data from the concept graph database 110 into spatial coordinates, colors, and/or shapes, allowing users to perceive the topological structure of the concept graph at a glance. The graph visualization interface 212 can support user interactions such as panning, zooming, and/or selecting individual nodes or edges for inspection or editing. Additionally, the graph visualization interface 212 can support drag-and-drop functionality, packaging an identifier of a dragged node or edge into a cross-component drag payload that the document editor pane 220 can interpret as a request to instantiate a concept block 222. Thus, the graph visualization interface 212 can bridge the source pane 210 and the document editor pane 220 in a single gesture, addressing the challenge of enabling users to directly manipulate the structured representation underlying generation and to select graph-derived entities from visual graph views into an editor to drive where and how generative evaluation occurs.

The graph visualization interface 212 can apply filter predicates derived from view presets and/or ad-hoc user queries to hide, dim, and/or accentuate subsets of nodes and edges. More specifically, the graph visualization interface 212 can enable focused inspection of relevant portions of the concept graph without mutating the underlying data in the concept graph database 110. This filtering and highlighting functionality can address the challenge of reducing mental overhead for users who must manage both document structure and detailed technical context, by allowing users to selectively view only those portions of the graph relevant to their current drafting task.

The graph visualization interface 212 can listen for click and/or tap events on graphical elements and raise selection callbacks carrying an identifier of the selected entity. In response, external modules can open property panels, fetch metadata, and/or log analytical events associated with the selected node or edge. Additionally, the graph visualization interface 212 can enable a user to directly edit the concept graph by creating new nodes and/or edges and by modifying attributes of existing nodes and/or edges within the visualization. Enabling entity selection for inspection and editing can provide visibility and control into what the system 100 has captured about the invention, thereby addressing the challenge of the ‘black box’ drafting process by allowing users to verify and validate the structured representation of concepts and relationships that underlies the generative document authoring process.

### Search & List View

As shown in FIG. 5, the source pane 210 can include a search and list view 214 that provides text-based access to entities present in the concept graph. Generally, the search and list view 214 can present graph entities in a tabular and/or flat list format, exposing nodes, edges, and/or associated attributes regardless of current visualization filters applied in the graph visualization interface 212. The search and list view 214 can include an incremental keyword search bar including a text input field that performs real-time, prefix-based matching against entity identifiers and/or metadata, updating the rendered list on each keystroke. Additionally, or alternatively, the search and list view 214 can include type and attribute filter controls, such as checkbox and/or drop-down widgets, that allow users to include or exclude entities by node class, edge class, attribute presence, modification timestamp and/or any other metadata attribute.

In one embodiment, the search and list view 214 can present entities in a hierarchical tree format. In this embodiment, entities can be grouped under expandable parent rows that mirror a class hierarchy of the concept graph, such as nodes grouped under component, step, or attribute parents, and/or edges grouped under relationship type parents. This hierarchical tree embodiment can assist users who prefer conceptual grouping over flat listings while preserving search and insertion mechanics of the search and list view 214.

### Document Editor Pane

As shown in FIG. 4 and FIG. 5, the document editor pane 220 can render and manage an editable structure of a long-form document. Generally, the document editor pane 220 can display an ordered, hierarchical arrangement of document blocks, including graph-derived blocks and/or non-graph blocks (e.g., free-text, images, and/or tables). The document editor pane 220 can support nesting of sections and/or content blocks to arbitrary depths, reflecting hierarchical relationships present in a concept graph. More specifically, each graph-derived block within the document editor pane 220 can maintain a persistent association (e.g., a pointer and/or reference) to a corresponding concept graph entity, enabling dynamic retrieval of context and/or attributes during document generation and/or editing. The document editor pane 220 can enable users to insert, rearrange, and/or delete blocks via direct manipulation, such as drag-and-drop and/or context menus. Additionally, the document editor pane 220 can provide visual feedback (e.g., previews of insertion points and/or block nesting) during block manipulation interactions. The document editor pane 220 can accept graph-derived entity insertion, wherein upon receiving a drag, click-to-insert, and/or programmatic command, the document editor pane 220 can instantiate a new editor block that is pre-populated with metadata linking the new editor block to a selected concept graph entity. In one implementation, the document editor pane 220 can position the new editor block at a user-specified hierarchy depth and/or recalculate sibling ordering to uphold a logical sequence of the document. Thus, the document editor pane 220 can address the challenge of high mental overhead by allowing users to directly manipulate document structure through graph-derived associations rather than manually managing both document structure and detailed technical context.

### Concept Block

As shown in FIG. 4 and FIG. 5, a concept block 222 can include a structured editor block within the document editor pane 220 that represents a selected concept graph entity and serves as a generative anchor for one or more paragraphs of long-form text. The concept block 222 can embed attribution metadata by attaching immutable identifiers, labels, and/or styling hooks to generated text, thereby enabling downstream components to highlight provenance and/or perform reverse look-ups to the originating graph item. Additionally, the concept block 222 can construct a position-aware prompt by building a formatted prompt that embeds the aggregated context alongside metadata describing the hierarchical position of the block, the document section, and/or desired writing style so that the generative model produces appropriately scoped output. The concept block 222 can also expose evaluation status by publishing real-time progress states to the editor UI, which allows visual indicators such as spinners, progress bars, and/or success badges to inform the user of pipeline advancement. Thus, the concept block 222 can provide a stable, machine-usable binding between the concept graph and specific locations in the evolving draft document, thereby addressing the technical challenges of maintaining visibility into generative model behavior, enabling traceable attribution from generated prose back to structured concept representations, and reducing the mental overhead associated with managing document structure and technical context.

In one embodiment, the concept block 222 can include a subtopic-containing concept block 222 that encapsulates multiple subtopic items, each of which represents a finer-grained conceptual facet of the associated graph entity of the block. The concept block 222 can maintain a pointer to a node, edge, and/or attribute in the concept graph, while additionally storing an ordered set of subtopic identifiers and/or references. During context construction and prompt generation, the system 100 can treat the subtopics as a local, intra-block structure, partitioning the block-level context bundle into subtopic-specific slices so that the generative module can produce one or more sentences targeted to each subtopic in sequence, rather than a single undifferentiated paragraph. By binding subtopics to the concept block 222 rather than creating separate blocks per subtopic, the subtopic-containing concept block embodiment can preserve existing interfaces and relationships between the concept block 222 and the editor block tree, context construction engine 130, and prompt construction engine 140, while reducing visual clutter and simplifying user manipulation. Therefore, the subtopic-containing concept block 222 can enable more precise, repeatable control over the internal structure of generated paragraphs, improving coverage of intended conceptual facets and reducing the mental overhead associated with coordinating fine-grained content within a graph-driven drafting workflow.

### Attribution Indicator

The document editor pane 220 can include an attribution indicator configured to render markers that associate generated text paragraph blocks with originating concept graph entities. In one embodiment, the attribution indicator implements a hover-activated tooltip approach that suppresses inline markers by default and/or reveals a tooltip containing provenance details when a user hovers over a paragraph, which can minimize visual noise while retaining full attribution information. In another embodiment, the attribution indicator implements a sidebar mapping approach that omits in-paragraph markers and/or instead renders a scroll-linked sidebar listing paragraph numbers grouped beneath originating graph entities, where clicking a sidebar entry can scroll the document editor pane 220 to a corresponding paragraph. In yet another embodiment, the attribution indicator implements persistent inline tags appended to the beginning of each generated paragraph, which can maximize immediacy of provenance information for users who prioritize traceability.

Context Construction Engine

Generally, the system 100 can include a context construction engine 130 that aggregates graph-derived context to support generative evaluation of document sections. The context construction engine 130 can programmatically assemble context payloads by traversing the concept graph from a focal graph entity (e.g., a node and/or edge associated with a document block) and collecting node contents, edge attributes, and/or metadata. The context construction engine 130 can assemble traversed information into an intermediate context object that captures the conceptual neighborhood of the document block under evaluation. Thus, the context construction engine 130 can address the absence of mechanisms to associate document locations with specific graph entities and to construct context for generation via a principled graph traversal process.

In one implementation, the context construction engine 130 can support multiple traversal strategies for constructing the intermediate context object from the concept graph. Generally, the context construction engine 130 can traverse graph entities according to edge distance from the focal graph entity, for example by performing breadth-first and/or depth-first traversal up to a configurable hop count and aggregating content from nodes and edges encountered within that distance. Additionally, or alternatively, the context construction engine 130 can restrict traversal to edges of selected types (e.g., hierarchy, input/output, and/or execution edges) so that the context construction engine 130 emphasizes structural, procedural, and/or data-flow relationships that are most relevant to the current document block. Further, the context construction engine 130 can observe edge directionality and can traverse along incoming and/or outgoing edges according to a traversal policy that reflects whether the document block is intended to describe prerequisites, consequences, or peer relationships of the focal graph entity. In one implementation, the context construction engine 130 can apply rule-based traversal over the graph structure, such as identifying root nodes within a subgraph reachable from the focal graph entity, constraining traversal to descendants or siblings of a particular node, and/or skipping portions of the graph that match exclusion rules. In another implementation, the context construction engine 130 can combine distance-based traversal, edge-type filters, directional policies, and structural rules within a single traversal plan so that the context construction engine 130 generates a context bundle that reflects both local neighborhood information and higher-level structural patterns of the concept graph.

In one implementation, the context construction engine 130 can dynamically adjust traversal depth based on block type, user settings, and/or detected prompt token budget. The context construction engine 130 can adapt the breadth and depth of graph exploration in real time to ensure compliance with model input limits while preserving essential detail. Thus, dynamic adjustment of traversal depth can address insufficient support for out-of-order drafting by allowing context scope to vary according to document position and/or available token capacity.

Additionally, or alternatively, the context construction engine 130 can apply distance-based and categorical weighting to aggregated context items. The context construction engine 130 can calculate relevance scores for each aggregated item according to configurable decay functions tied to graph distance and/or document hierarchy distance, and can further associate each item with a categorical importance level that determines a target degree of summarization. In one implementation, the context construction engine 130 can assign items to tiers (e.g., high, medium, and low relevance) and can preserve full text for high-relevance items while generating progressively more compressed summaries for lower-relevance items before inclusion in the intermediate context object. In this manner, the context construction engine 130 can prioritize information most pertinent to the current drafting locus while controlling verbosity of less central material, thereby addressing the difficulty of maintaining a consistent and stable representation of concepts and relationships across the entire drafting lifecycle within available model input capacity.

### Prompt Construction Engine

Generally, as shown in FIG. 1, the system 100 can include a prompt construction engine 140 configured to generate structured prompts for evaluation by a generative model. The prompt construction engine 140 can receive a context bundle produced by the context construction engine 130 and synthesize the context bundle with metadata describing a document type, semantics of an associated graph entity, and/or a position of a subject concept block 222 within a document hierarchy. The prompt construction engine 140 can format the prompt as a machine-readable instruction set that includes explicit instructions regarding an intended document section or content type, a payload containing aggregated node contents and relevant attributes from the concept graph, formatting guidance specifying output structure, length, style, and/or attribution requirements, and/or directives for integrating unevaluated and/or sibling content blocks. The prompt construction engine 140 can include a prompt template library storing multiple prompt template and/or schemas, which can be selected based on the document type, block type, and/or user configuration. Additionally, or alternatively, the prompt construction engine 140 can include a prompt builder configured to bind aggregated context values to placeholder fields within a selected template, expand conditional clauses, and/or materialize a final instruction set in a field order dictated by a schema registry. The prompt construction engine 140 can output the constructed prompt to a generative module adapter 300 via an API and/or other programmatic interface. Thus, the prompt construction engine 140 addresses the challenge of maintaining a repeatable, graph-structured workflow by algorithmically constructing prompts from a persistent structured representation rather than from ad hoc prompting.

In one embodiment, the prompt construction engine 140 can implement adaptive template selection using a machine-learning classifier configured to predict an optimal template identifier. The classifier can receive as inputs historical user acceptance data of previously generated text, document genre indicators, and/or block metadata. The classifier can continuously update weights based on feedback signals, such as user edits and/or acceptance rates, to yield progressively improved prompt template matches over time. Alternatively, the prompt construction engine 140 can implement rule-based template selection according to predefined criteria associated with document type and/or block type. Therefore, adaptive template selection can reduce mental overhead for users by automatically matching prompt template to document contexts based on learned preferences and historical outcomes.

In another embodiment, the prompt construction engine 140 can employ an internal lightweight reasoning agent configured to iteratively refine a preliminary prompt. The reasoning agent can query additional graph context and/or external retrieval modules until predefined completeness criteria are satisfied. The reasoning agent can execute autonomously without blocking a user interface thread, thereby supporting asynchronous and/or agentic prompt generation. In this embodiment, the prompt construction engine 140 can operate in a decoupled manner from context construction, enabling parallel processing of prompt refinement operations. This agentic prompt refinement approach addresses the challenge of inadequate support for algorithmically deriving prompt content by enabling principled, iterative context augmentation prior to generative model evaluation.

### Generative Module Adapter

As shown in FIG. 1, the system 100 can include a generative module adapter 300 configured to interface between the system 100 and one or more external generative models. Generally, the generative module adapter 300 can receive a structured prompt constructed by the prompt construction engine 140 and transmit the structured prompt to an external generative model via an application programming interface (API) call. The generative module adapter 300 can support synchronous and/or asynchronous communication protocols, and can accommodate various authentication, rate limiting, and/or error handling requirements imposed by an external generative model provider. Upon receiving generated text output from the external model, the generative module adapter 300 can provide the output to the document editor pane 220 for insertion into the document at the appropriate location. In one implementation, the generative module adapter 300 can support model-agnostic operation, enabling the system 100 to utilize different types of generative models (e.g., large language models, rule-based generators, and/or hybrid system 100) without requiring changes to the core document generation workflow. Additionally, or alternatively, the generative module adapter 300 can include mechanisms for logging, monitoring, and/or auditing prompt submissions and responses, as well as for handling retries and/or fallbacks in the event of failed or suboptimal responses from the external model.

In one implementation, the system 100 can alternatively include a locally executing generative module that receives the structured prompt without traversing an external API boundary. In such an implementation, the generative module adapter 300 can be omitted, and the system 100 can instead invoke a local inference engine and/or library that executes within the same computing environment as the system 100, while the remaining context construction and prompt construction behavior remains substantially unchanged.

### Graph Validation Module

As shown in FIG. 1, the system 100 can include a graph validation module 150 configured to maintain structural integrity and consistency of the concept graph. Generally, the graph validation module 150 can perform preventative validation for user interface edits and/or post-validation for AI-mediated graph edits. In preventative validation, the graph validation module 150 can intercept user-initiated modifications to the concept graph—such as addition, deletion, and/or modification of nodes, edges, node attributes, and/or edge attributes—prior to application of the changes. The graph validation module 150 can evaluate a proposed edit against a set of structural and/or logical constraints, which can include graph connectivity requirements, node and/or edge type compatibility, attribute value ranges, and/or referential integrity between graph entities and associated document blocks. If an edit would violate a constraint, the graph validation module 150 can block the action and/or provide feedback to a user indicating the nature of the violation. In post-validation, the graph validation module 150 can review changes to the concept graph that are applied via automated and/or AI-mediated processes, such as tool-calling by a generative model and/or batch updates. The graph validation module 150 can analyze the resulting graph structure to detect violations of structural rules, such as orphaned nodes, cycles in acyclic graphs, invalid attribute assignments, and/or broken associations between graph entities and document blocks. Upon detecting an inconsistency, the graph validation module 150 can trigger corrective actions, such as reverting the change, flagging the issue for user review, and/or automatically repairing the concept graph if a deterministic correction is possible. The graph validation module 150 can operate in real time and/or in batch mode, and can support extensible validation rule sets to allow adaptation to different document domains and/or graph ontologies. Additionally, the graph validation module 150 can log validation events and detected issues for auditability and/or debugging purposes, and can interface with the graph-change propagation module 160 to ensure that validated changes are consistently reflected in both the concept graph and the associated document structure.

### Graph-Change Propagation Module

As shown in FIG. 1, the system 100 can include a graph-change propagation module 160 configured to monitor and respond to modifications made to the concept graph during and/or after document drafting. Generally, the graph-change propagation module 160 can detect edits to the concept graph, such as the addition, deletion, and/or modification of nodes, edges, and/or attributes, and can identify document blocks within the document data model 120 that are associated with the affected graph entities. More specifically, the graph-change propagation module 160 can analyze the nature and scope of a graph change to determine which document blocks may require re-generation, targeted edits, and/or user review. In one implementation, the graph-change propagation module 160 can present a notification and/or prompt to a user, indicating specific document blocks impacted by the graph change and offering options for propagating the change, such as re-evaluating the generative model for affected blocks, suggesting targeted modifications, and/or maintaining existing text. The graph-change propagation module 160 can utilize rule-based logic, dependency tracking, and/or generative AI tool calls to assess the impact of a graph change and to recommend and/or automate appropriate updates to the document. Additionally, or alternatively, the graph-change propagation module 160 can operate in real-time and/or batch mode and can support user-configurable propagation policies (e.g., automatic, manual, and/or hybrid propagation). Thus, the graph-change propagation module 160 can maintain consistency between the structured concept graph and the generated document content, thereby reducing manual rework and ensuring that edits to the underlying conceptual representation are reliably reflected in the long-form document.

### Method of User-Guided Long-Form Document Generation Using a Concept Graph

Generally, the method S100 of user-guided long-form document generation using a concept graph can include a sequence of actions enabling the structured, repeatable creation of long-form technical documents from a concept graph. The method S100 can enhance user visibility by presenting transparent, editable representations of what the system 100 has captured—from graph topology to prompt content—at each stage, allowing a drafter to audit, correct, and strategically sculpt document scope without blind prompting cycles. Additionally or alternatively, the method S100 can optimize prompt efficiency by constructing prompt contexts that maximize relevance while minimizing token count, thereby controlling API cost and/or latency without sacrificing the richness required for high-quality technical exposition. The method S100 can also reduce cognitive load by shifting the burden of remembering complex inter-component details from the human drafter to the graph and traversal algorithms of the system 100, freeing the user to focus on higher-level strategic drafting decisions. Further, the method S100 can support out-of-order drafting by enabling users to populate and evaluate document sections in any sequence while still receiving coherent, non-redundant text, aligning drafting flow with human brainstorming rather than forcing linear progression. Thus, the method S100 addresses challenges of prior drafting system 100 by coupling a persistent structured representation of concepts and relationships with principled graph traversal for context construction, enabling a workflow in which document sections can be generated from the concept graph rather than from ad hoc prompting and/or iterative re-prompting.

### Generate Concept Graph From Input Documents

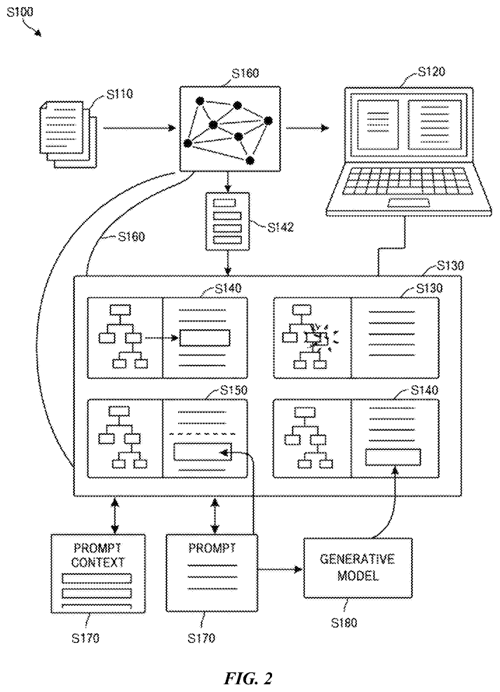

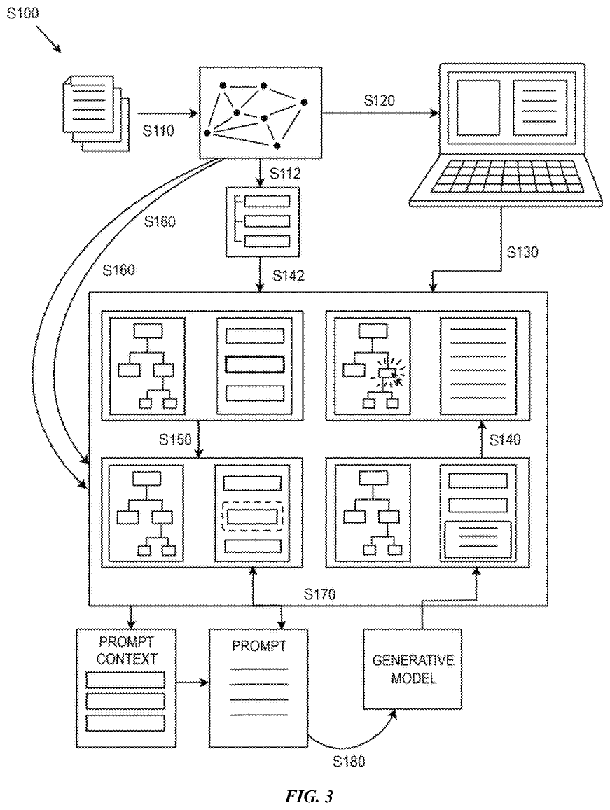

As shown in FIG. 2 and FIG. 3, the system 100 can generate a concept graph from input documents to establish front-loaded context stabilization and/or structured knowledge encoding for downstream document generation in step S110. Generally, the system 100 can receive one or more source documents and process the source documents to produce a concept graph including nodes and edges that encode the technical subject matter in a machine-readable format. More specifically, the generation of the concept graph can occur early in the drafting workflow to establish a persistent, canonical representation of relevant concepts and relationships, thereby minimizing context drift that would otherwise occur as the document evolves. Thus, the concept graph can serve as a stable foundation from which subsequent steps—such as document structuring, context construction, and generative evaluation—can reference concepts deterministically rather than heuristically.

In one implementation, the system 100 can leverage a domain-specific rule engine to generate the concept graph. The domain-specific rule engine can utilize pattern-matching rules, such as regular expressions and/or dependency parse templates, tuned to the language conventions of the target document domain (e.g., patent language) to extract components, steps, and interactions from the source documents. This approach can yield highly structured graphs even when operating on small datasets where machine learning models may underperform.

The system 100 can acquire input documents by receiving one or more data sources containing subject matter to be used as the basis for long-form document generation. The system 100 can ingest a variety of input types, including user-uploaded files in standard formats (e.g., DOCX, PDF, TXT, and/or XML), text pasted directly into a user interface, URLs referencing web-accessible resources, and/or data streams received via application programming interfaces. In one embodiment, the system 100 can perform initial validation to confirm file integrity, supported format, and/or accessibility upon receipt. The acquired input documents can serve as the foundational data from which the concept graph is generated in subsequent substeps.

Subsequently, the system 100 can parse and extract conceptual entities from the acquired input documents. This substep can comprise processing the input documents to identify discrete conceptual entities, relationships, and/or attributes relevant to the subject matter using generative AI models, natural language processing techniques, pattern matching algorithms, and/or rule-based extraction logic. The system 100 can tokenize the input text, segment sentences, and/or apply entity recognition models to detect candidate concepts such as components, processes, relationships, and/or features. The output of this substep can be a set of structured data elements—each representing a concept, relationship, or attribute—suitable for instantiation as nodes and edges within the concept graph.

The system 100 can then build nodes and edges by instantiating the extracted conceptual entities within a graph data structure. Each node can correspond to a discrete concept, component, process step, and/or other domain-specific entity, and each edge can represent a defined relationship or interaction between two or more nodes. The system 100 can apply ontology labels to nodes and edges, where such labels are selected and/or defined based on the requirements of the document domain. In some embodiments, the instantiation of nodes and edges can be performed automatically, semi-automatically with user verification, and/or manually by a user depending on workflow requirements.

The system 100 can validate and store the concept graph prior to persistence for downstream use. This substep can include performing schema validation to ensure that nodes, edges, and associated attributes conform to a predefined and/or dynamically determined ontology, including type constraints, required fields, and/or permitted relationships. Additionally or alternatively, referential integrity checks can be performed to confirm that edge references correspond to existing nodes and that there are no orphaned or dangling references within the graph data structure. Upon successful validation, the system 100 can persist the concept graph to a storage medium in a format suitable for subsequent retrieval and use in document structuring, context construction, and/or generative evaluation.

### Serialize Concept Graph Into Initial Document Structure

As shown in FIG. 3, the system 100 can serialize the concept graph into an initial document structure in step S112. In one embodiment, the document data model 120 algorithmically transforms the concept graph into an ordered, hierarchical list (or outline) comprising sections and/or content blocks. The serialization process can derive a coherent outline by mapping nodes, edges, and/or attributes to corresponding positions within the document hierarchy based on domain-specific rules and/or graph topology. Additionally or alternatively, the resulting document structure can enable out-of-order drafting by representing unevaluated sections and content blocks as placeholders that preserve structural integrity and contextual linkage throughout the drafting process.

More specifically, the context construction engine 130 can analyze the graph topology of the concept graph. In one implementation, the analysis includes examining hierarchical relationships, connectivity patterns, and/or attribute distributions among nodes and edges. The system 100 can calculate metrics such as node degree, edge types, node attribute density, and/or subgraph connectivity to determine which concept graph items are suitable for representation as document headings, subheadings, or leaf content blocks. For example, nodes with high connectivity or centrality can be mapped to higher-level sections, while nodes with fewer connections or specialized attributes can be mapped to lower-level sections and/or content blocks. The analysis can further include traversing the graph to identify parent-child relationships, cycles, and/or clusters, and assigning hierarchical levels accordingly.

Subsequently, the system 100 can instantiate content blocks based on the ordered hierarchical list. In one implementation, for each concept graph item identified for inclusion in the document, the system 100 creates a corresponding editor block programmatically associated with the originating concept graph item via a persistent reference and/or pointer. The instantiation process can occur in response to user actions and/or automatically as part of the algorithmic serialization of the concept graph into the document structure. The editor blocks can include section blocks, content blocks, and/or subtopic blocks, each corresponding to different types and/or hierarchical levels of concept graph items. Thus, the persistent linkage between editor blocks and concept graph items supports subsequent operations such as context construction for generative evaluation, propagation of graph edits to the document, and/or attribution of generated text to source concepts.

### Present Concept Graph to User

Generally, the method S100 can include presenting a set of concept graph items in the concept graph to a user in step S120. As shown in FIG. 4, the user interface module 200 can render a visual representation of the concept graph that encodes structured relationships and attributes of concepts relevant to a long-form document. The system 100 can display the concept graph in one or more configurable source pane 210, which can include a graphical visualization of nodes and edges, a searchable list view, and/or a text-based search interface. In one implementation, the visual representation can be configured to show all or a subset of nodes, edges, node attributes, and edge attributes according to user-selected and/or system 100-defined view presets. The visual representation can include interactive elements that allow the user to inspect, select, and edit nodes, edges, and attributes of the concept graph. More specifically, the system 100 can enable the user to verify, validate, and modify the structured representation prior to and/or during document generation, thereby exposing structured context and enabling verification and correction of graph elements before those elements drive text generation. This approach can address the challenge of providing visibility into what a generative language model has captured about an invention, and can reduce propagation of extraction errors by allowing correction before downstream generation steps.

In one implementation, the system 100 can support a multi-view comparative layout in which two or more synchronized views render the same underlying concept graph with different presets. For example, one view can show only hierarchical edges while another view can show attribute dependencies and/or other edge types. Selecting a node in one view can highlight the corresponding element in all synchronized views, aiding cross-relation analysis. Additionally or alternatively, the system 100 can support multiple simultaneous views, each with independently configurable visibility of graph elements. Thus, the multi-view comparative layout can provide the user with a faithful, machine-generated yet human-readable depiction of all concepts and relationships extracted from source material, supporting grounded and validated drafting actions throughout the document generation workflow.

As shown in FIG. 5, the system 100 can instead present the concept graph as a search and list view 214 (e.g., hierarchical tree and/or sortable or searchable list of concept graph items). Each row and/or entry in the list-only interface can include quick-action controls (e.g., buttons and/or links) for inserting a selected graph entity into the document editor pane 220 and/or for editing attributes of the graph entity. Thus, the search and list view 214 can address the challenge of providing a machine-usable yet human-readable representation of concepts and relationships that can drive document generation.

### Receive User Selection of Concept Graph Entity and Position Within the Document Editor

As shown in FIG. 2, the method S100 can include receiving user selection of a graph entity and position within the document editor pane 220 in step S130. Generally, the system 100 can receive, at the document editor pane 220, a user selection event that resolves to a specific concept graph item within the concept graph and/or a placement event that specifies a target insertion location within the document data model 120. More specifically, during a selection phase, the user interface module 200 can detect a selection gesture originating from any graph-derived interface, such as the graph visualization interface 212, a search result list, and/or the search and list view 214, and can resolve that gesture into a selected graph entity reference identifying a node, an edge, a node attribute, and/or an edge attribute in the concept graph. During a placement phase, the document editor pane 220 can receive a subsequent placement gesture that specifies a structural position between existing editor blocks and/or onto a section block or other container block, thereby defining a location within the hierarchical editor block tree. This step addresses the technical challenge of enabling users to directly manipulate the structured representation underlying generation by separating semantic selection of a concept from structural placement decisions, thereby mapping the persistent, graph-structured representation into specific document locations in a repeatable manner.

Generally, the system 100 can detect a selection gesture by interpreting user and/or programmatic input events to identify a selected concept graph item within the user interface module 200. More specifically, the system 100 can monitor for pointer-based events (e.g., mouse clicks, touch events, and/or stylus taps), keyboard-based events (e.g., keyboard shortcuts, navigation keys, and/or enter/return key presses), and/or programmatic selection events (e.g., API calls and/or automated agent actions) that specify a target graph item. Upon receiving such an event, the system 100 can determine the identity of the selected graph item by mapping the event context—such as cursor position, focused element, and/or event payload—to a unique identifier of a graph entity in the underlying concept graph data structure.

In one implementation, the user interface module 200 can support drag-and-drop placement, wherein the system 100 registers pointer-down events on selectable graph-entity representations, tracks cursor movement, displays a live ghost block that shadows the cursor, and on pointer-up within the document editor pane 220 calculates the nearest valid insertion index. In another implementation, the system 100 can support context-menu placement, wherein upon right-clicking a graph entity, the user interface module 200 presents a context menu with insert options such as ‘As Section,’ ‘As Content Block,’ and/or ‘As Subtopic,’ and upon selection switches focus to the document editor pane 220 and highlights permissible drop zones. In yet another implementation, the system 100 can support keyboard-shortcut placement, wherein when a graph entity is focused in a list and/or visualization, the user can press a defined shortcut (e.g., Ctrl+Enter), and the system 100 auto-inserts the concept block 222 immediately after the currently active editor block. These multiple interaction modalities address the technical challenge of providing interfaces that allow users to drag-and-drop or otherwise select graph-derived entities from visual graph views, search, and/or lists into an editor to drive where and how generative evaluation occurs.

Generally, the system 100 can insert a concept block 222 by creating a new document block at a user-specified position within the document editor pane 220 in step S140. More specifically, upon creation, the concept block 222 can be programmatically associated with the selected concept graph item by storing a persistent reference, such as a block-graph association pointer and/or unique identifier, within the data structure of the concept block 222, thereby enabling the concept block 222 to retrieve context and content from the corresponding concept graph item at runtime. The insertion process can support arbitrary nesting within the document hierarchy, allowing concept block 222 to be placed at any depth and/or in any order within the editor block tree. The system 100 can maintain the pointer between the concept block 222 and the concept graph item throughout subsequent document editing and evaluation steps, ensuring that any updates to the concept graph item are reflected in the associated concept block 222. Thus, this linkage mechanism enables subsequent processes, such as context construction and prompt generation, to access the full set of attributes and relationships of the associated concept graph item for use in generative evaluation.

Additionally or alternatively, as shown in FIG. 3, the document data model 120 can pre-generate a plurality of concept block 222 within the document editor pane 220 based on a serialization of the concept graph, where the document data model 120 can instantiate unevaluated concept block at locations defined by an initial document outline derived from graph topology analysis in step S142, thereby allowing the user to subsequently edit, reposition, or initiate evaluation of pre-generated concept block 222 while maintaining linkage between each unevaluated concept block and a corresponding graph entity.

### Trigger Evaluation of Concept Block

As shown in FIG. 2 and FIG. 3, the system 100 can trigger evaluation of a concept block 222 in step S150. Generally, the concept block 222 can receive an evaluation input that initiates transformation of the concept block 222 into generative text within the document editor pane 220. The evaluation input can be provided through a user interface element, such as a button click, a menu selection, a keyboard shortcut, and/or a drag-and-drop action, or can alternatively be initiated programmatically by the system 100. Upon receiving the evaluation input, the system 100 can identify the subject concept block 222 and the associated concept graph item, and can proceed to initiate context construction and prompt generation. In some implementations, the evaluation input can be associated with additional parameters, such as a scope of evaluation (e.g., a single block, multiple blocks, and/or an entire section) and/or user-specified instructions to modify generative behavior. The triggering of evaluation can support out-of-order drafting, allowing users to evaluate concept block 222 in any sequence, and can further support reversible evaluation, wherein generated text can be reverted to the original concept block 222 representation without loss of linkage to the concept graph. Thus, the triggering of evaluation enables the system 100 to transition from a structured, graph-derived representation of document content to natural language output while maintaining a persistent association between the generated text and the originating concept graph item, thereby addressing the lack of visibility into what a generative language model has captured and supporting traceability and validation of generated technical content.

### Construct Generative Context via Graph Traversal

Generally, as shown in FIG. 2 and FIG. 3, the context construction engine 130 can construct prompt context via graph traversal to deliver highly relevant prompt context for evaluating a selected concept block 222 in step S160. In one implementation, the system 100 can traverse the concept graph beginning from the graph entity associated with a subject concept block 222, aggregating node contents, edge attributes, and/or relationship data into a context bundle. The traversal can apply a proximity-based weighting scheme wherein information from graph entities closer to the starting node is weighted more heavily, and information from more distant entities is weighted less or omitted. Thus, by foregrounding proximate, high-value nodes and attributes, the step mitigates hallucinations and improves factual accuracy of generated text, addressing the challenge of delivering machine-usable yet contextually rich information for generative evaluation.

More specifically, the context construction engine 130 can traverse a proximity neighborhood by beginning from the subject concept graph item and aggregating node contents from a set of traversed nodes. The context construction engine 130 can modulate traversal depth and/or breadth according to the graph distance between each traversed node and the subject concept graph item, such that nodes closer to the subject are traversed with greater depth and contents of those nodes are weighted more heavily. The context construction engine 130 can implement proximity-based weighting using a decay function (e.g., exponential or linear decay) applied to relevance or inclusion of node contents as a function of graph distance. Therefore, the context construction engine 130 can ensure that prompt context is densely populated with relevant information from the immediate neighborhood while minimizing inclusion of redundant or less relevant data from distant nodes.

Additionally, the context construction engine 130 can aggregate and weight context data by consolidating node contents and/or edge attributes from the concept graph into a structured context object. The context construction engine 130 can assign numeric weights and/or establish an ordering for each item within the structured context object to reflect relative relevance to the subject concept block 222 being evaluated. The context construction engine 130 can determine the weighting based on proximity within the concept graph, hierarchical relationships, node type, attribute type, and/or user-defined rules. The context construction engine 130 can then provide the resulting structured context object as input to prompt construction and subsequent generative model evaluation, thereby enabling a generative model to receive context that is prioritized according to structural and semantic relationships present in the concept graph.

In one implementation, the system 100 can execute document-position weighted traversal wherein the system 100 modulates traversal parameters according to the nesting depth of the subject block within the document. The system 100 can configure top-level sections to invoke broader, shallower traversals to gather system 100-wide context, while the system 100 can configure deeply nested subtopics to trigger focused, deep traversals with narrower breadth. The context construction engine 130 can thereby align the granularity of context with the narrative zoom level of the document structure, thus enabling the system 100 to derive context construction parameters from document hierarchy rather than relying on ad hoc prompting.

In another implementation, the system 100 can employ agentic traversal wherein the system 100 instantiates an autonomous agent process that executes a sequence of traversal operations rather than following a single fixed traversal pattern. The system 100 can inspect the associated graph entity, the current document hierarchy, and/or unevaluated sibling or ancestor blocks to formulate one or more traversal goals. The system 100 can iteratively issue traversal sub-queries, evaluate intermediate results against heuristics or learned policies (such as coverage, redundancy, and/or topical relevance), and conditionally refine or extend the traversal frontier. This implementation enables the system 100 to construct prompt contexts that are more targeted and semantically appropriate than prompt contexts produced by purely static traversal strategies.

In yet another implementation, for concept blocks linked to an edge entity or concept graph item, the system 100 can employ edge-centric dual-origin traversal such that the system 100 concurrently traverses from both connected nodes. The system 100 can merge context streams from both branches along with the attribute payload of the edge itself. A redundancy filter can resolve overlapping information between the two branches. This implementation accurately captures bidirectional relationships without bias toward either node.

Alternatively, the system 100 can employ graph-plus-vector hybrid retrieval wherein, after completing a traversal of the concept graph, the system 100 issues a vector similarity query against an embedding index of all node contents. Top-K results not already included can be merged into the context using an additional retrieval weight parameter. This hybrid approach injects semantically similar but topologically distant information, improving recall of relevant details that pure graph distance metrics might otherwise miss.

In one implementation, the context construction engine 130 can execute a hierarchy-aware traversal mode that first climbs a graph hierarchy to gather ancestor nodes that define broader system 100 context, and then descends into child nodes to collect fine-grained specifics. The context construction engine 130 can leverage ontology tags, such as hierarchy edges, to orchestrate a traversal sequence so that section-level overviews precede component-level details in a prompt context. The system 100 can adjust weighting parameters to privilege ancestor nodes for scope framing while still incorporating leaf-node attributes that contribute fine-grained detail.

In another implementation, the system 100 can employ token-budget adaptive traversal wherein, prior to traversal, the system 100 estimates remaining allowable tokens based on a context size cap and/or current document length. The system 100 can dynamically reduce depth, breadth, and/or attribute verbosity until the projected context fits within the token budget. Real-time adjustments can include collapsing long attribute lists into summaries and/or skipping low-weighted branches, thereby averting API rejections and/or latency issues while maintaining context quality.

### Construct Prompt Based on Document Position

Generally, the system 100 can construct a prompt based on document position of the subject concept block 222 in step S170. In this step, the prompt construction engine 140 can generate a structured prompt for a generative model by embedding a context bundle within a prompt template that incorporates metadata describing the position of the subject concept block 222 within the long-form document. The prompt construction engine 140 can determine metadata including the hierarchical level of the concept block 222 (e.g., section, subsection, or content block), the sequence of the concept block 222 within a parent section, identities and/or summaries of sibling blocks, and/or relevant parent or ancestor section headings. Additionally, the prompt construction engine 140 can select, from the prompt template library, a document-type instruction set specifying requirements for technical writing style, formatting conventions, and/or content scope, based on a document type (e.g., patent application, technical report, legal brief). The system 100 can inject such structural context into the structured prompt so that the generative model scopes output appropriately and/or avoids duplicating material from other sections. Further, the prompt construction engine 140 can encode explicit references to unevaluated concept block in the structured prompt so that the generative model accounts for pending and/or future content in the document structure and avoids contradictions when those sections are later evaluated. Additionally, the system 100 can embed document-type-specific instructions within the structured prompt so that generated paragraphs maintain stylistic consistency across the entire draft and reduce post-generation editing effort. Thus, the prompt construction engine 140 can algorithmically derive context and structure for generation based on document position using principled mechanisms rather than ad hoc prompting.

More specifically, the prompt construction engine 140 can construct a prompt based on document position by appending generation instructions. In this substep, the prompt construction engine 140 can incorporate style, tone, and/or formatting directives into the prompt by aggregating one or more instruction sets that specify desired linguistic characteristics, document conventions, and/or formatting requirements. The prompt construction engine 140 can append instructions that include directives specifying target document type, preferred writing style (e.g., formal, concise, explanatory), tone (e.g., neutral, persuasive), and/or formatting rules (e.g., paragraph structure, heading conventions, citation style). The prompt construction engine 140 can perform prompt template selection to determine which pre-defined or dynamically constructed template the system 100 uses as scaffolding for the prompt, where each template can specify the ordering of context sections, locations of placeholders, delimiter syntax, and/or static system 100 instructions. The system 100 can select different templates (e.g., a patent-drafting template versus a technical-report template) to directly change rhetorical framing and/or formatting of generated text without modifying downstream steps. Therefore, the prompt construction engine 140 can append generation instructions so that the system 100 produces document sections consistent with user expectations and/or domain-specific standards.

Additionally, the prompt construction engine 140 can embed context into a prompt template. In this substep, the prompt construction engine 140 can populate a structured prompt template with context segments that have been aggregated and/or weighted based on relevance to the subject concept block 222. The prompt construction engine 140 can insert context segments—such as node contents, edge attributes, and/or other graph-derived data—into one or more placeholders or designated insertion points within the template. The prompt construction engine 140 can determine the selection and/or ordering of context segments according to a proximity-based weighting algorithm, which can assign higher priority to context derived from graph entities that are closer to the subject concept block 222 in the document hierarchy and/or graph topology. The prompt construction engine 140 can perform the embedding process by formatting the context segments according to template requirements, such as converting structured data into natural language, applying section headers, and/or including attribution metadata. Thus, the prompt construction engine 140 can embed context into a prompt template to enable consistent and repeatable integration of structured, graph-derived context into generative workflows, addressing the challenge of constructing generation context via principled graph traversal and proximity-based weighting.

In one implementation, the prompt construction engine 140 can include an agentic LLM prompt builder. The prompt construction engine 140 can leverage a separate language model acting as an agent to read the context bundle and/or metadata and then compose an optimized prompt text. The prompt construction engine 140 can cause the meta-LLM to rephrase headings, compress verbose graph content, and/or inject style directives tailored to the downstream generative engine. This implementation of the prompt construction engine 140 can provide higher flexibility at the cost of an additional model call, enabling the system 100 to adapt dynamically to varying content types and/or document requirements.

In another implementation, the prompt construction engine 140 can include a dynamic rule-based assembler. The prompt construction engine 140 can employ a rules engine that selects among numerous micro-templates based on block type, document depth, and/or detected graph entity types. The prompt construction engine 140 can apply the rules to control heading encoding, attribute selection, and/or other prompt construction parameters, enabling fine-grained adaptation without invoking a language model to build the prompt itself. This implementation of the prompt construction engine 140 can provide deterministic and computationally efficient prompt construction while maintaining adaptability to diverse document structures and/or entity types.

### Evaluate Generative Model to Obtain Text

Generally, after construction of the structured prompt, the system 100 can evaluate a generative model to obtain text corresponding to an unevaluated concept block in step S180. The generative module adapter 300 can transmit the structured prompt, which includes context aggregated from the concept graph and/or information about a position of the concept block 222 within the document, to a generative model via an application programming interface (API) and/or other programmatic interface. The generative model can be a large language model (LLM) and/or any other generative artificial intelligence system 100 capable of producing natural language text. Upon completion of evaluation, the system 100 can capture the generative output and prepare the generative output for insertion into the document editor pane 220 at a location corresponding to the concept block.

More specifically, to submit the prompt to an external API, the generative module adapter 300 can transmit a prompt payload from the system 100 to an external generative model service via a network interface. The prompt payload can include the structured prompt text and/or associated model parameters such as temperature, maximum token count, stop sequences, and/or other configuration values. The network call can utilize standard protocols such as HTTP and/or HTTPS, and can include authentication credentials and/or API keys as required by the external service. In one implementation, the system 100 can support asynchronous submission, where the network call returns an external API request identifier and the generated output is retrieved in a subsequent request.

Subsequently, to receive generated output, the generative module adapter 300 can accept a model response payload from the generative model in the form of a token stream, text blob, and/or other structured data representing the generated content. The system 100 can parse the model response payload to extract relevant textual content, metadata, and/or attribution information as required by the document data model 120. The parsed output can be temporarily stored in a memory buffer and/or designated storage location within the system 100 for subsequent processing, such as rendering in the document editor pane 220, associating with the originating concept block 222, and/or enabling further user interaction.

In one implementation, the system 100 can support streaming token rendering, where the API connection remains open and streams tokens as Server-Sent Events (SSE). The document editor pane 220 can render each token and/or small chunk in real time, thereby providing users with immediate visual feedback and/or the ability to abort the generation mid-flow if content diverges from expectations. Thus, the evaluate generative model to obtain text step can produce generated text paragraphs for subsequent insertion and attribution within the draft document.

### Replace Concept Block With Generated Text and Attribution

Generally, the document editor pane 220 can replace a concept block 222 with one or more paragraph blocks containing text generated by the generative model in step S190. The replacement operation can remove the visual representation of the concept block 222 from the editor and insert the generated paragraph blocks at the same location within the document structure. Each generated paragraph block can be tagged with metadata that associates the block with the originating concept graph item and/or the specific prompt used for generation, thereby facilitating traceability and validation of the generated content. In one implementation, the system 100 can perform batch section-scoped replacement, wherein a single evaluation command issued at a section header causes the system 100 to iterate sequentially through all descendant concept block 222, or invoke generation in parallel, and swap each block in place once the respective output arrives.

More specifically, the system 100 can display generated paragraphs by rendering, within the document editor pane 220 interface, one or more paragraphs of text produced by the generative model. The document editor pane 220 can determine the formatting of each generated paragraph according to a block type and/or a hierarchical position of the block within the document structure, such that visual appearance (e.g., indentation, font style, heading level, and/or attribution markers) reflects the logical organization of the document. The system 100 can apply a visual attribution indicator style parameter to configure a user interface affordance, such as a color band, icon overlay, inline label, tooltip, and/or outline gutter marker, that surfaces linkage of each generated paragraph to an originating concept graph item.

Additionally, the system 100 can maintain reversion capability by providing a reversible mapping between a generated paragraph block and the originating concept block 222. The system 100 can, upon user input, replace a previously generated paragraph block with the original concept block 222, thereby restoring an association between a document location and a corresponding concept graph entity. The system 100 can preserve all linkage information during reversion, including pointers and/or references to an underlying concept graph node, edge, or attribute, as well as any metadata required for subsequent context construction and/or prompt generation. The system 100 can define an attribution metadata schema that specifies fields encoded into each generated paragraph block, such as a source-graph item identifier, a prompt hash, a model version, a generation timestamp, and/or a user session identifier, which can determine both a granularity of traceability and a storage footprint.

### Propagate Graph Changes to Existing Document

Generally, the system 100 can propagate graph changes to an existing document. The graph-change propagation module 160 can detect an edit to the concept graph after the system 100 has generated one or more paragraphs and/or document sections and can analyze an impact of a modification on a document structure and content of the draft document with attributed prose. The system 100 can identify document blocks, sections, and/or paragraphs that the system 100 associates with modified graph entities, including nodes, edges, and/or attributes that the system 100 has added, deleted, and/or edited. In one implementation, the system 100 can prompt a user to confirm whether to propagate detected changes. More specifically, the system 100 can determine a scope of affected document locations when a user confirms propagation and can offer targeted actions, which can include re-evaluating document blocks whose associated graph entities have changed, suggesting inline edits to generated text to reflect updated graph content, and/or flagging sections for manual review. The graph-change propagation module 160 can maintain graph-document consistency by synchronizing the draft document with attributed prose with a current state of the concept graph and can thereby support traceability throughout a drafting lifecycle. Additionally, the system 100 can minimize manual rework by using the graph-change propagation module 160 to intelligently identify and update portions of the document that a graph change impacts, thereby reducing cognitive burden on a user and saving drafting time.

In one implementation, the graph-change propagation module 160 can perform background auto-propagation. In this implementation, the graph-change propagation module 160 can monitor the concept graph for mutations and can, upon detection, queue affected blocks for regeneration in a low-priority background thread. Once rendering completes, the graph-change propagation module 160 can replace stale content with updated paragraphs without requiring explicit user interaction and can coordinate with the user interface module 200 to present a notification badge and/or other visual indicator that indicates that automatic synchronization occurred. Thus, the graph-change propagation module 160 can favor speed and minimal user interruption during fast-moving drafting sessions.

In another implementation, the graph-change propagation module 160 can operate in an inline suggestion mode. In this implementation, the graph-change propagation module 160 can insert inline suggestions and/or tracked changes at locations where updates are needed instead of immediately replacing text. The system 100 can enable a user to accept, reject, and/or manually edit each suggestion and can thereby integrate smoothly with familiar word-processing paradigms. Thus, the graph-change propagation module 160 can provide granular user control over which propagated changes are applied to the draft document with attributed prose.

### Automatic Evaluation Variant

Generally, in the automatic evaluation variant, the system 100 can automatically trigger of generative evaluation for one or more concept blocks without explicit user initiation. More specifically, the system 100 can monitor user activity within the document editor pane 220 and, upon detecting a period of user inactivity exceeding a configurable threshold duration (e.g., between 1 and 30 seconds), can initiate the evaluation process for one or more unevaluated concept block. Alternatively, the system 100 can trigger automatic evaluation based on system 100-defined heuristics, such as completion of a block, navigation away from a section, and/or detection of a stable editing state. In this variant, the context construction engine 130, the prompt construction engine 140, and/or the generative module adapter 300 can operate asynchronously in background threads or processes to aggregate relevant graph-derived context, construct prompts, and call an external generative model. Upon completion of generative evaluation, the system 100 can notify a user via visual indicators, notifications, and/or inline updates, and can visually replace corresponding concept block 222 with the generated text. Additionally, the automatic evaluation variant can support batch evaluation of multiple blocks, prioritization of evaluation order based on document structure and/or user focus, and/or configurable user preferences for automatic versus manual evaluation. In one implementation, the system 100 can allow a user to override and/or revert automatic evaluations, and can provide settings to adjust the inactivity threshold, enable or disable automatic evaluation, and/or specify which blocks are eligible for automatic evaluation. Thus, the automatic evaluation variant can streamline the drafting workflow and reduce manual intervention by eliminating the requirement for an explicit evaluate action for each concept block 222, thereby addressing the technical challenge of high mental overhead for users who must manually manage both document structure and detailed technical context when using generative tools for long-form drafting.

We claim:

1. A method for long-form document generation comprising:
generating a concept graph from a set of input documents, the concept graph comprising a set of concept graph items comprising:
a set of nodes, each node in the set of nodes containing node contents; and
a set of edges;
at a user device:
rendering a visual representation of the set of concept graph items;
receiving a selection of a subject concept graph item, from the set of concept graph items, for inclusion in a long-form document;
in response to receiving the selection of the subject concept graph item, rendering a subject concept block for the subject concept graph item within a document editor pane of the long-form document; and
receiving an evaluation input associated with the subject concept block
in response to receiving the evaluation input associated with the subject concept block:
traversing the concept graph starting from the subject concept graph item, to aggregate the node contents of each traversed node in a set of traversed nodes within a prompt context;
constructing a prompt based on a position of the subject concept block within the long-form document; and
evaluating a generative model based on the prompt context and the prompt, to generate a generative output; and
at the user device, visually replacing the subject concept block with the generative output.

2. The method of claim 1, wherein the visual representation of the set of concept graph items comprises a visual representation of the concept graph.

3. The method of claim 2, wherein receiving the selection of the subject concept graph item comprises receiving a drag-and-drop input dragging a visual representation of the subject concept graph item from the visual representation of the concept graph into the document editor.

4. The method of claim 1, wherein the visual representation of the set of concept graph items comprises a visual list of the set of concept graph items.

5. The method of claim 1, wherein constructing the prompt further comprises constructing the prompt based on an attribute of the subject concept graph item.

6. The method of claim 1, further comprising, at the user device, receiving an input to revert the generative output to the subject concept block, and in response to receiving the input to revert the generative output, visually replacing the generative output with the subject concept block.

7. The method of claim 1, wherein the visual representation of the set of concept graph items is rendered in a first pane of the user device and the document editor pane is rendered in a second pane of the user device.

8. The method of claim 1, wherein the generative model is a large language model.

9. The method of claim 1, further comprising, at the user device:
receiving an edit to the node contents of the subject concept graph item resulting in edited node contents, wherein the edit is received in association with the visual representation of the set of concept graph items; and
in response to traversing the concept graph starting from the subject concept graph item, including the edited node contents in the prompt context.

10. The method of claim 1, further comprising:
at the user device, receiving a user edit to the concept graph; and
in response to a propagation input, evaluating the generative model to update the generative output based on the user edit.

11. A method for long-form document generation comprising:
generating a concept graph from a set of input documents, the concept graph comprising a set of concept graph items comprising:
a set of nodes, each node in the set of nodes containing node contents; and
a set of edges;
serializing the concept graph as an ordered hierarchical list of the set of concept graph items;
at a user device:
for each concept graph item in the set of concept graph items, rendering a concept
block in a set of concept block in a document editor pane of a long-form document based on the ordered hierarchical list of the set of concept graph items;
receiving an evaluation input associated with a subject concept block in the set of concept block, the subject concept block for a subject concept graph item in the set of concept graph items;
in response to receiving the evaluation input associated with the subject concept block:
traversing the concept graph based on the subject concept graph item and neighboring concept graph items in the ordered hierarchical list of the set of concept graph items, to aggregate the node contents of each traversed node in a set of traversed nodes within a prompt context;
constructing a prompt based on a position of the subject concept block within the long-form document; and
evaluating a generative model based on the prompt context and the prompt, to generate a generative output; and
at the user device, visually replacing the subject concept block with the generative output.

12. The method of claim 11, wherein traversing the concept graph based on the subject concept graph item and the neighboring concept graph items comprises applying a proximity-based weighting to the node contents of each traversed node, wherein a first traversed node closer to the subject concept graph item in the ordered hierarchical list is weighted more heavily than a second traversed node farther from the subject concept graph item in the ordered hierarchical list.

13. The method of claim 11, wherein constructing the prompt further comprises constructing the prompt based on an attribute of the subject concept graph item.

14. The method of claim 11, wherein the ordered hierarchical list defines a set of hierarchical levels, and wherein for each concept graph item in the set of concept graph items, a hierarchical level in the set of hierarchical levels of the concept graph item corresponds to a nesting depth of the concept block within the document editor.

15. The method of claim 14, wherein the set of concept block comprises a set of section blocks and a set of content blocks, each section block in the set of section blocks corresponding to a non-leaf concept graph item in the ordered hierarchical list and each content block in the set of content blocks corresponding to a leaf concept graph item in the ordered hierarchical list.

16. The method of claim 11, further comprising, at the user device, receiving an input to revert the generative output to the subject concept block, and in response to receiving the input to revert the generative output, visually replacing the generative output with the subject concept block.

17. The method of claim 11, wherein the generative model is a large language model.

18. The method of claim 11, wherein constructing the prompt further comprises including, in the prompt, a representation of a set of unevaluated concept block in the set of concept block, each unevaluated concept block in the set of unevaluated concept block associated with a respective concept graph item in the set of concept graph items.

19. The method of claim 11, wherein the subject concept graph item is associated with an edge in the set of edges connecting a first node and a second node in the set of nodes, and wherein traversing the concept graph comprises aggregating the node contents of the first node and the node contents of the second node within the prompt context.

20. The method of claim 11, further comprising:
at the user device, receiving a user edit to the concept graph; and
in response to a propagation input, evaluating the generative model to update the generative output based on the user edit.
